(19) United States
(12) Patent Application Publication
(10) Pub. No.: US 2011/0242799 A1
(43) Pub. Date: Oct. 6, 2011

(54) LIGHTING APPARATUS

(76) Inventor: Simon Dyer, Christchurch (NZ)

(21) Appl. No.: 12/158,663

(22) PCT Filed: Dec. 22, 2006
(86) PCT No.: PCT/NZ06/00342

§ 371 Date: Aug. 24, 2009

Related U.S. Application Data
(60) Provisional application No. 60/753,743, filed on Dec. 22, 2005.

(51) Int. Cl. F21V 21/084

(52) U.S. Cl. 362/105

(57) ABSTRACT

The invention describes a hat or cap comprising a light or a plurality of lights within a visor portion of the hat or cap so as to improve the quality of light offered by such devices while maintaining the aesthetics and comfort of a standard hat or cap. In some embodiments, the hat or cap comprises an activation switch that adjusts the light in a number of different settings and may also include a solar panel located within the visor portion.

### STATEMENT OF CORRESPONDING APPLICATIONS

This application is based on U.S. Provisional Patent Application No. 60/653,743, the entire contents of which are incorporated herein by reference.

### TECHNICAL FIELD

This invention relates to a hands free lighting assembly mounted onto the brim or visor of a hat such as a baseball cap. More particularly the invention relates to the integration of several known technologies such as power sources, lights and solid state electronics all arranged in a particular manner to provide a product that requires minimal maintenance and provides a light source.

### BACKGROUND ART

Portable lighting devices are well known and used, particularly in the outdoors, for example hand held MagLite™ torches. A development from such hand held torches has been the manufacture of hands free devices such as the Petzyl™ style head worn spotlight. A similar device also exists for attachment to bicycle helmets for night cycling. One problem with such hands free devices is that they are usually not integrated into another item e.g. apparel. They are also not aesthetically pleasing as they are very obvious visually.

An alternative to the above lighting systems is the concept of integrating a light into a hat. However, hat embodiments have included various problems that have influenced the usefulness of the products and their aesthetic appeal.

United States Design, USD 489,165 illustrates one such light and cap design. The cap utilizes a battery worn on the rear of the cap beanie portion and has two small lights which project from the edge of the visor portion of the cap. This cap has the disadvantage of components being located on both the beanie and visor portion therefore requiring more parts and the need to also specifically manufacture the beanie portion. The battery size also suggests that the battery is likely to weigh a significant amount and therefore the cap will be less comfortable to wear. Finally, with the lights positioned on the edge of the visor, the lights are vulnerable to impacts such as being dropped and also reflect light into the eyes of the user when worn.

United States Patent Application No 2002/0186180 describes a cap with many functions for communications and entertainment. LED lights are described as being integrated into the underside of the cap visor in order to confirm operation (not for lighting generally). A solar panel along with batteries is used to power the cap functions. This cap does not use lights as an aid to help the user view objects in the dark. In addition, the aesthetic appeal of the cap is low with most elements of the design being visible and not hidden.

United States Patent Application No. 2002/0186557 describes a cap which has a lighting bar attached above the visor of the cap using Velcro™. The bar includes an array of LED lights. Again, this bar is highly visible, very obvious and would not be aesthetically appealing to a user who wants to wear a cap that appears like a normal cap. In addition given the assembly, it is likely that the lighting bar proposed would have a weight significant enough to unbalance the cap and possibly lead to the cap falling off the user's head.

U.S. Pat. No. 5,510,961 describes a cap with a visor that includes an electronics assembly which can record and generate sound. The assembly also includes ornamental LED lights around the outer edge of the visor. The lights used are for ornamental purposes and the cap also appears to be of little aesthetic appeal having a relatively thick visor portion.

U.S. Pat. No. 5,741,060 describes a cap device with light bulbs located under the visor portion of the cap. The design described requires a strengthened crown portion of the head engaging portion of the cap in order to retain the device batteries and associated circuitry. This is not desirable as it requires the beanie portion of the cap to be manufactured especially for this application. In addition, the lights and switch protrude from the bottom of the visor portion of the cap to the point where they are prone to damage from impacts such as being dropped. Further, with the light bulbs in such close proximity to the user's eyes, the glare from the bulbs in the user's eyes is likely to be significant.

U.S. Pat. No. 6,659,618 describes a cap device using two small LED lights located on the edge of the visor portion of the cap. These lights are powered using a battery located at the reverse of the cap. As stated above, having a battery and associated circuitry in the beanie portion of the cap is not desirable as it requires the beanie portion of the cap to be manufactured especially for this application. In addition, the battery is visible and therefore of less visual appeal to a person wanting to wear a cap with a light that still looks largely like a standard cap. In addition, the lights protrude from the edge of the visor portion of the cap to the point where they are prone to damage from impacts such as being dropped and also reflect light into the eyes of the user when worn.

U.S. Pat. No. 6,721,962 is similar to U.S. Pat. No. 6,659,618 above however, the battery power source is located in the crown of the cap and a longitudinal bar is used for lighting rather than point source LED lights. As stated above, having a battery and associated circuitry in the beanie portion of the cap is not desirable as it requires the beanie portion of the cap to be manufactured especially for this application. Also, as a bar light source is used, the light produced is likely to be less bright and also not able to be focused or directed to the same extent as a point source of light. Finally, as the light source is mounted at the edge of the visor portion, the lighting bar is also prone to damage from impacts such as the cap being dropped.

Such prior art hat structures do not adequately protect the light source from impact, such as by being dropped or protect light glare from the user's eyes. In addition, selected devices require that the assembly also be included in the head mounted portion of the hat, thus requiring additional reinforcing in the hat portion. Further, the above examples are all not aesthetically pleasing in that they look obviously different to a normal cap. Further, the above examples may be heavy or unbalanced in nature, e.g., where batteries are located in the hat beanie portion such as the crown.

It is an object of the present invention to address the foregoing problems or at least to provide the public with a useful choice.

All references, including any patents or patent application's, cited in this specification are hereby incorporated by reference. No admission is made that any reference constitutes prior art. The discussion of the reference states what their authors assert, and the applicants reserve the right to challenge the accuracy and pertiency of the cited documents. It will be clearly understood that, although a number of prior art publications are referred to herein, this reference does not constitute an admission that any of these documents forms parts of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention, there is a visor portion capable of being attached to a head engaging portion, wherein the visor portion has a first upward facing surface (first surface) and a second downward facing surface (second surface); characterised in that the visor portion contains at least one bubble projection on the second surface which contains at least one light emitting source.

The inventor of the present invention has developed a visor portion for use in a hat such as a baseball cap wherein the visor portion includes an improved lighting assembly to provide illumination for a user of the hat while still maintaining the aesthetics and comfort of a normal hat.

In preferred embodiments, the bubble projection or projections are either releasably attached to the visor portion or integral with the visor portion. Preferably, the bubble projection or projections are located centrally on the second surface of the visor portion. In preferred embodiments, wherein the visor includes two bubble projections, each bubble projection may be located at distal ends of the second surface.

In further preferred embodiments, the projections have at least one forward facing translucent aperture through which light is directed. In one embodiment envisaged by the inventor, the aperture includes one or more lenses to focus light emitted from the light emitting source. In a preferred embodiment, the apertures are moulded to form a lens shape at manufacture to provide the desired degree of focus or dispersion and/or field of vision. This should not be seen as limiting as it should be appreciated that adjustable lenses may also be provided for users to adjust as desired in order to focus or disperse the light emitted or adjust the field of vision. The translucent aperture is also designed so as to avoid glare from the light emitting device being directed at the user's eyes when the hat is worn. It should be appreciated that, as the light or lights are in close proximity to the user's eyes, it is desirable to ensure that light emitted is directed into the desired direction away from the user's eyes.

In preferred embodiments, the visor portion may be sealed to be substantially water resistant and also to assist in shock proofing the device. In one embodiment envisaged, the visor portion may have a reinforced edge which seals the visor portion together. Preferably, this edging is formed using a rubber based substance such as, e.g., Santoprene™.

In preferred embodiments, the visor portion may be flexible in a substantial vertical orientation. However, it should be appreciated that, as the visor surface may be arcuate (or curved), flexing the visor in a vertical orientation may alter the horizontal orientation as well. Preferably, the visor thickness when assembled is less than 5 mm extending out to less than 15 mm over the bubble projection or projections. It should be appreciated that flexibility is advantageous as it allows the visor to be attached to various shaped head engaging portions, e.g., helmets as well as baseball caps. Flexibility in the example of a baseball cap also allows the visor to be adjusted to fit the user's head shape.

In one embodiment, the visor portion is releasably attachable to the head engaging portion, allowing the user to remove the visor whilst still wearing the head engaging portion (e.g. a beanie portion). In this embodiment, it is envisaged that the visor portion may then be releasably attachable to other objects, such as a bag.

Optionally, the top section may be textured or coloured so that the solar panel is not visible when worn.

In preferred embodiments, the light emitting source is at least one light emitting diode (LED). It should be appreciated that other light emitting sources may also be used without departing from the scope of the invention such as halogen or tungsten bulbs. Preferably, one LED device is used per bubble projection. LED light sources are preferable due to their long lifetime, low weight, and minimal power usage for given light output and intensity duration.

In preferred embodiments, the power source includes at least one photo voltaic solar panel that collects light through the first surface of the visor. In one embodiment, the solar panel is centrally located under the first surface of the visor. In an alternative embodiment, the solar panel is shaped around the front 2 cm edge of the visor. In a particularly preferred embodiment, the solar panel is flexible. Preferably, the power source may also include at least one battery, either with or without a solar panel being present. Preferably, the visor portion includes at least one battery embedded within the visor portion. More preferably, the battery or batteries are embedded within the one or more bubble projections. In a preferred embodiment, the battery or batteries are rechargeable with replacement charge being provided by a solar panel.

In preferred embodiments, the visor portion's first and second surfaces are separate sections, made from plastic and the sections are sealed together. Preferably, the second section contains bossing moulding to retain the visor's components, selected from: lights, batteries, solar panel, wiring, and combinations thereof.

Preferably, the visor portion contains substantially all of the lighting circuit including the power source or sources and the lights themselves so that the head engaging portion remains independent of the lighting circuit. This has the advantage that the visor can be retrofitted into existing beanie designs or other hats/helmets such as bicycle helmets, caving helmets, safety helmets, and the like. In addition, having the visor independent of the beanie portion removes the need for additional features on the beanie portion, such as reinforcing, wiring and batteries.

In preferred embodiments, the electronic module is made up of solid state components. In one embodiment, the electronic module is a circuit sandwiched between the first and second surface of the visor portion and connects the power source or sources to the light emitting device or devices. In preferred embodiments, the electronic module includes a pulse width modulation (PWM) capability enabling the ability to vary the duty cycle of the lighting circuit. This has the advantage that, as the power source reduces in intensity, the lighting circuit can be adjusted using PWM to maintain an even level of brightness from the light or lights. PWM also provides the advantage of being able to monitor battery charging to avoid over charging and monitor the rate of discharge to avoid battery or bulb damage.

In preferred embodiments, the visor portion includes an activation switch. In preferred embodiments, the activation switch is recessed into a second surface of the visor portion. It is envisaged that the activation switch may complete one or more of the following functions:
(a) turn the light or lights on;
(b) turn the light or lights off;
(c) place the lights into an on or off sequence;
(d) adjust the light brightness.

In one embodiment, the switch has ‘one-click’ and ‘double-click’ functionality to access differing functions in a similar manner to how a computer mouse is used to access different functions on a computer. Also, one function envisaged is that, if the activation switch is held down, the light or lights brighten or dim to a setting desired by the user. Other functions also envisaged include options such as a strobe option and the ability to alter the strobe timing which may be useful for example as a novelty option, e.g., party mode, or in situations where increased visibility is required such as when cycling or sending an SOS signal.

According to a further aspect of the present invention, there is a visor portion capable of being attached to a head engaging portion wherein the visor portion has a first upward facing surface (first surface) and a second downward facing surface (second surface); characterised in that the visor portion contains at least one activation switch, a light emitting source projecting from the second surface characterised in that the activation switch is used to complete one or more of the following functions:
(a) turn the light or lights on;
(b) turn the light or lights off;
(c) place the lights into an on or off sequence;
(d) adjust the light brightness.

It should be appreciated from the above description that there is provided a lighting device that has various advantages over the prior art including improved light intensity and direction from the use of bubble projections on the underside of the visor. In addition, as the lights are contained underneath the visor and within a plastic casing, the visor is more robust than previous designs and able to withstand normal wear and tear better. Also, as the electronic circuitry, including the lights and power source(s), are sealed within the visor, the visor is water resistant. By having a combination of power sources (solar and battery) and use of long life light sources (LEDs), the visor of the present invention also has the advantage that the visor needs minimal opening and servicing, if required at all. Further, as the light source or sources are located in one or more bubble projections with a defined outlet aperture, light may be directed away from the user's eyes, thus avoiding unwanted glare. In addition, the above features also come together to provide an aesthetically pleasing design that hides the lighting function yet still provides lighting functionality when required.

The device has various applications in a multitude of outdoor pursuits, such as, e.g., camping, hiking, boating and fishing, as well as novelty value use and uses in practical situations, such as, e.g., farming, servicing machinery, and even as an alternative to a torch at home.

Other features and advantages of the present invention will become apparent from the following detailed description, taken in conjunction with the accompanying drawings, which illustrate by way of example, the features of the present invention.

### BRIEF DESCRIPTION OF DRAWINGS

FIG. 1 illustrates a bottom view of a hat or cap, in accordance with preferred embodiments of the present invention;

FIG. 2 illustrates a perspective section view of the underside of a visor portion of a hat or cap, in accordance with preferred embodiments of the present invention;

FIG. 3 illustrates a perspective view (from above) of a visor portion of a hat or cap, in accordance with preferred embodiments of the present invention; and

FIG. 4 illustrates a perspective detail view of a portion of the underside of a visor portion of a hat or cap, in accordance with preferred embodiments of the present invention.

### BEST MODES FOR CARRYING OUT THE INVENTION

In general, the present invention allows the incorporation of a light or a plurality of lights within the visor or brim portion of a hat, cap and the like, so as to improve the quality of light offered by such devices whilst still maintaining the aesthetics and comfort of a standard hat, cap and the like.

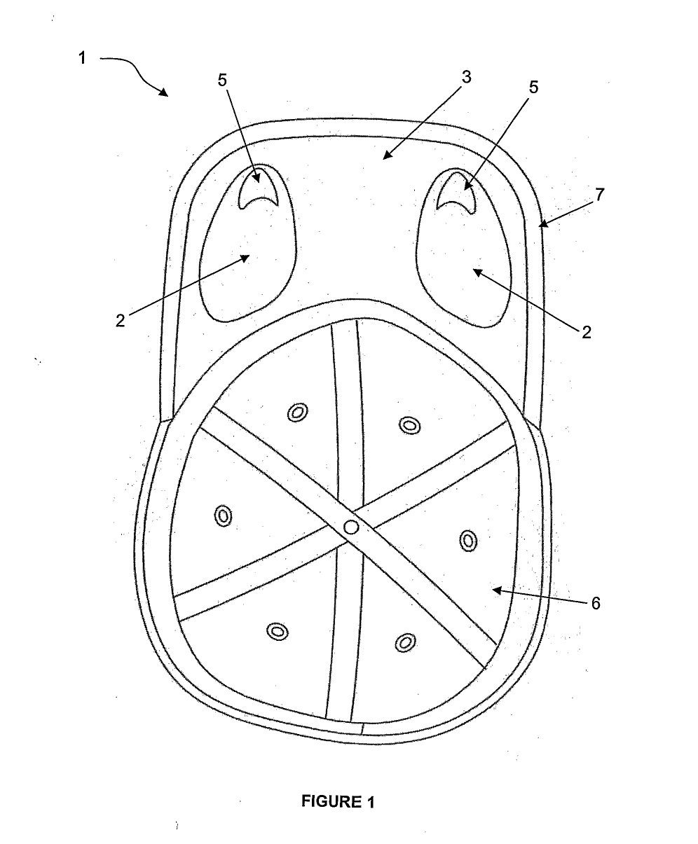

Reference will now be made to the figures, wherein like reference numerals denote like or corresponding parts throughout the figures. More particularly, FIGS. 1-4 illustrate a lighted cap (or hat) 1 constructed in accordance with the present invention.

According to a preferred embodiment, a cap (or hat) 1, constructed in accordance with the present invention, provides an improved level of illumination via use of bubble projections 2 to house the LED light or plurality of lights 4 on the underside of the visor portion 3 of the cap 1. The bubble projections 2 also obscure the lights 4 from view during normal use, allowing the overall look and feel of a normal hat. One advantage of the bubble projections 2 is that light can be directed and focused via translucent aperture lenses 5 on the forward facing portions of the bubble projections 2. In addition, the bubble projections 2 strengthen the overall structure of the visor portion 3 and protect the lights 4 themselves, thus making the cap 1 as a whole stronger, more robust and better able to withstand normal wear and tear.

In a preferred embodiment, the cap 1 includes a head engaging portion 6 and a visor portion 3. The visor portion 3 includes two bubble projections 2 centrally located on the underside of the visor portion 3. Each bubble projection 2 includes a forward facing translucent aperture 5 through which light passes. Light is emitted from LED lights 4 contained within the bubble projections 2 and is focused and directed via the apertures 5 in a direction forward of the user when the cap 1 is worn.

The edge of the visor portion 3 may be strengthened using a reinforcing material 7 which encloses the edge of the visor portion 3. In the embodiment shown, the reinforcing material 7 overlaps the edge of the visor portion 3 continuously along the length of the visor portion 3 edge. It is preferable that this reinforcing material 7 be made from a flexible material, such as, e.g., rubber. In one preferred embodiment, the rubber is Santoprene™. It should be appreciated that a flexible material 7 assists in absorbing shocks (caused by, e.g., dropping of the cap) better than other more rigid materials. In addition, flexible material 7 still allows the visor portion 3 to be moulded to fit the shape of the user's head. In addition, by firmly sealing the edge of the visor portion 3, a degree of water resistance is gained and the visor portion 3 is generally strengthened to withstand normal wear and tear.

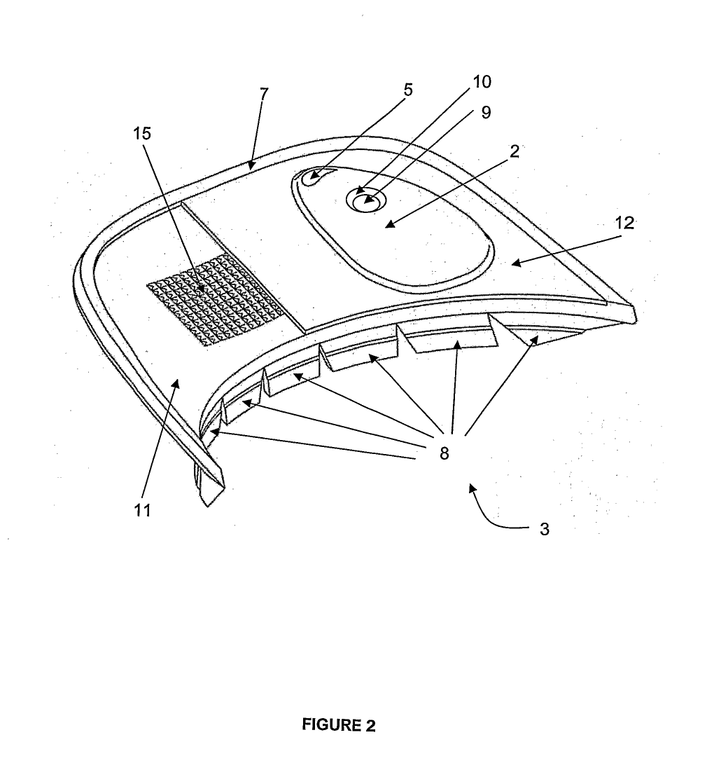

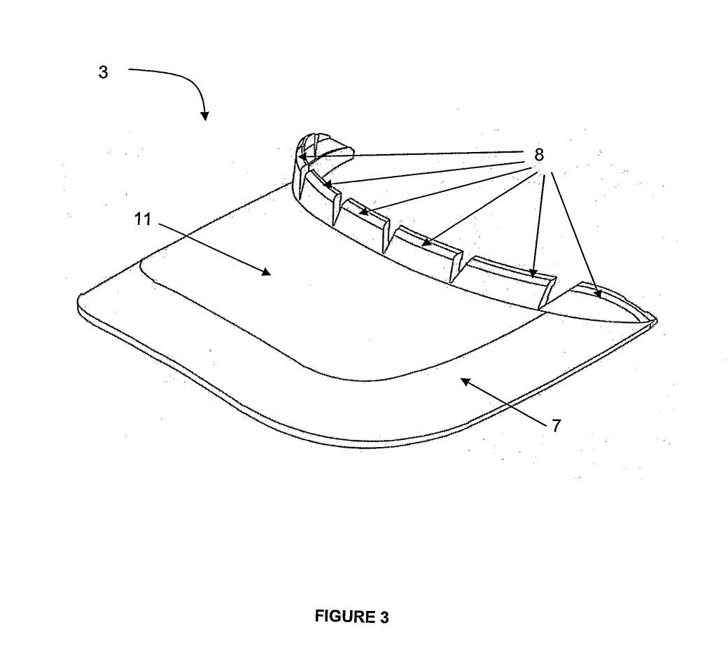

As shown in FIGS. 2-3, the visor portion 3 may optionally include connecting tabs 8. The tabs 8 ideally run along the length of the inside arcuate portion of the visor portion 3 and are used to attach the visor portion 3 to the head engaging portion 6. In one embodiment, it is envisaged that the two portions 3, 6 will be attached via use of stitching. In an alternative embodiment, the two portions may be attached using a releasable assembly, such as, e.g., via use of a hook and loop or Velcro™ attachment mechanism. In this way, the visor portion 3 may be removed from the head engaging portion 6 and optionally attached to another article such as a backpack or cycle helmet (not shown).

As shown in FIG. 2, the visor portion 3 includes an activation switch 9. The switch 9 is located within a recessed portion 10 of one bubble projection 2 in the visor portion 3. It is envisaged that by depressing the switch 9, the lights 4 will be turned on or off, or various other functions will be activated. As mentioned above, other functions envisaged include a ‘one-click’ and ‘double-click’ functionality to access differing functions in a similar manner to how a computer mouse is used to access different functions on a computer. As an example, if the switch is depressed once, the lights turn on. If depressed twice, the lights 4 cycle through a range of strobe type functions which can be selected by a single button press. A strobe option is envisaged being advantageous as a novelty option, e.g., party mode, or in situations where increased visibility or assistance by others is required, such as when cycling or sending a distress signal (i.e., SOS). Also envisaged is a function whereby, if the activation switch 9 is held down, the light or lights 4 brighten or dim to a setting desired by the user. It should be appreciated that various other functions may also be employed without departing from the scope of the invention as described.

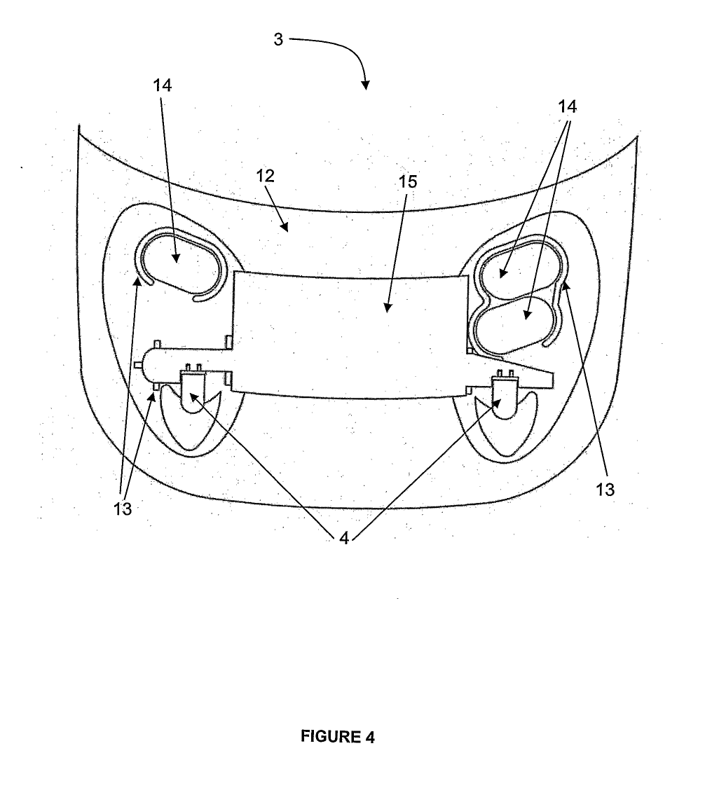

In the illustrated embodiments, the visor portion 3 is defined by two plastic sections, one being a top section 11 and the other being a bottom section 12. As shown in FIG. 4, the bottom plastic section 12 includes moulded sections for the bubble projections 2 and bossed areas 13. As shown in the embodiment of FIG. 4, the visor portion 3 includes a total of three batteries 14 located within appropriately shaped bossed sections 13. A solar panel 15 is located across the central section of the visor portion 3 between the two bubble projections 2. The collecting surface of the solar collector 15 faces the top section 11 through which sunlight passes to charge the solar collector 15. LED lights 4 are located in the forward facing section of each bubble projection 2 and are held in place using appropriately-shaped bossing 13. A ribbon cable (not shown) is situated between the two bubble projections 2 and electrically links the solar collector 15, batteries 14 and LED lights 4.

As stated above, light passes through the top plastic section 11 to the solar collector 15 located between the top section 11 and bottom section 12. To allow light to pass through the top section 11 and also look aesthetically pleasing, it is envisaged that the top section 11 will be sufficiently transparent to allow light to pass through and yet not so transparent that the collector 15 will be clearly visible. One embodiment envisaged is for the solar collector 15 to be lightly coloured or textured to mask the visibility of the collector 15.

The various embodiments described above are provided by way of illustration only and should not be construed to limit the invention. Those skilled in the art will readily recognise various modifications and changes that may be made to the present invention without following the example embodiments and applications illustrated and described herein, and without departing from the true spirit and scope of the present invention.

1. A visor portion capable of being attached to a head engaging portion, wherein the visor portion has a first upward facing surface (first surface) and a second downward facing surface (second surface); characterised in that the visor portion comprises at least one part ovoid shaped bubble projection on the second surface which houses at least one light emitting source.

2. The visor portion as claimed in claim 1, wherein the bubble projection(s) are integral with the visor portion.

3. The visor portion as claimed in claim 1, wherein the bubble projection(s) are releasably attached to the visor portion.

4. The visor portion as claimed in claim 1, wherein the visor comprises one bubble projection located centrally on the second surface of the visor portion.

5. The visor portion as claimed in claim 1, wherein there are two bubble projections with each projection located at distal ends of the second surface of the visor portion.

6. The visor portion as claimed in claim 1, wherein the bubble projection(s) have at least one forward facing translucent aperture.

7. The visor portion as claimed in claim 6, wherein the aperture(s) comprises at least one lens.

8. The visor portion as claimed in claim 6, wherein the aperture(s) are moulded to form a lens shape to restrict the glare of the light emitting source away from the user's eyes while the visor portion is in use.

9. The visor portion as claimed in claim 7, wherein lens(es) are adjustable.

10. The visor portion as claimed in claim 1, wherein the visor portion is releasably attached to a head engaging portion.

11. The visor portion as claimed in claim 10, wherein the visor portion may be releasably attached to an object.

12. The visor portion as claimed in claim 1, wherein the first and second surfaces of the visor portion are separate sections.

13. The visor portion as claimed in claim 12, wherein the first and second surfaces of visor portion are sections joined and reinforced about the edges to seal the visor portion together.

14. The visor portion as claimed in claim 1, wherein the light emitting source is at least one light emitting diode (LED).

15. The visor portion as claimed in claim 14, wherein there is one LED device per bubble projection.

16. The visor portion as claimed in claim 1, wherein the visor portion comprises at least one power source.

17. The visor portion as claimed in any one of the preceding claims, wherein the second surface retains components selected from: lights, batteries, solar panel, wiring, and combinations thereof.

18. The visor portion as claimed in claim 16, wherein the power source comprises at least one photo voltaic solar panel that collects light through the first surface of the visor.

19. The visor portion as claimed in claim 18, wherein the solar panel is centrally located under the first surface of the visor.

20. The visor portion as claimed in claim 18, wherein the solar panel is flexible.

21. The visor portion as claimed in claim 16, wherein the power source includes at least one battery.

22. The visor portion as claimed in claim 21, wherein the battery or batteries are embedded within the visor portion.

23. The visor portion as claimed in claim 21, wherein the battery or batteries are embedded within the bubble projection(s).

24. The visor portion as claimed in claim 21, wherein the battery or batteries are rechargeable with replacement charge being provided by a solar panel.

25. The visor portion as claimed in claim 1, wherein the visor portion comprises an electronic module, wherein the electronic module is electrically connected to a power source for receiving power from the power source and which is also electrically connected to the at least one light emitting source.

26. The visor portion as claimed in claim 25, wherein the electronic module comprises a pulse width modulation (PWM) capability.

27. The visor portion as claimed in claim 1, wherein the visor portion comprises an activation switch.

28. The visor portion as claimed in claim 27, wherein the activation switch is recessed into the second surface of the visor portion.

29. The visor portion as claimed in claim 27, wherein the activation switch is used to complete one or more of the following functions:
(a) turn the light or lights on;
(b) turn the light or lights off;
(c) place the lights into an on or off sequence;
(d) adjust the light brightness.

30. The visor portion as claimed in claim 32, wherein the switch has ‘one-click’ and ‘double-click’ functionality to access differing functions.

31. A visor portion as claimed in claim 27, wherein the switch has a function wherein if the activation switch is held down, the light or lights brighten or dim to a setting desired by the user.

32. A visor portion capable of being attached to a head engaging portion wherein the visor portion comprises a first upward facing surface (first surface) and a second downward facing surface (second surface); characterised in that the visor portion contains at least one activation switch, at least one light emitting source housed within at least one part ovoid shaped projection on the second surface wherein the activation switch is used to complete one or more of the following functions:
(a) turn the light or lights on;
(b) turn the light or lights off;
(c) place the lights into an on or off sequence;
(d) adjust the light brightness.

33. The visor portion as claimed in claim 32, wherein the activation switch is recessed into a second surface of the visor portion.

34. The visor portion as claimed in claim 32, wherein the switch has ‘one-click’ and ‘double-click’ functionality to access differing functions.

35. The visor portion as claimed in claim 32, wherein the switch has a function wherein if the activation switch is held down, the light or lights brighten or dim to a setting desired by the user.

36. The visor portion as claimed in claim 32, wherein the light emitting source is at least one LED.

37. The visor portion as claimed in claim 32, wherein there is one light emitting source located centrally on the second surface of the visor portion.

38. The visor portion as claimed in claim 32, wherein there are two light emitting sources each source located at distal ends of the second surface of the visor portion.
